(19) United States
(12) Patent Application Publication
(10) Pub. No.: US 2023/0063897 A1
(43) Pub. Date: Mar. 2, 2023

(54) VEHICLE

(71) Applicant: TOYOTA JIDOSHA KABUSHIKI KAISHA, Toyota-shi (JP)

(72) Inventors: Takayuki HAMADA, Okazaki-shi (JP); Yohsuke HASHIMOTO, Nagakute-shi (JP); Yuki OGAWA, Toyota-shi (JP); Masakazu AOKI, Nagoya-shi (JP)

(73) Assignee: TOYOTA JIDOSHA KABUSHIKI KAISHA, Toyota-shi (JP)

(21) Appl. No.: 17/816,123

(22) Filed: Jul. 29, 2022

(30) Foreign Application Priority Data
Aug. 26, 2021 (JP) 2021-138186

(51) Int. Cl. G08G 1/0967

(52) U.S. Cl. CPC G08G 1/0967

(57) ABSTRACT

A vehicle includes a traffic obstruction information acquisition device configured to acquire traffic obstruction information, a vehicle information acquisition device configured to acquire vehicle information related to a second vehicle located between a position of the vehicle and a location on the traveling route where a traffic obstruction has occurred, a notification device configured to give, to a driver of the vehicle, a notification by a first notification method and a notification by a second notification method, and a control device configured to notify the driver of the traffic obstruction information by the first notification method when a predetermined condition that brings difficulty for the driver in recognition of the traffic obstruction is not satisfied based on the vehicle information, and notify the driver of the traffic obstruction information by the second notification method when the predetermined condition is satisfied based on the vehicle information.

### CROSS-REFERENCE TO RELATED APPLICATION

This application claims priority to Japanese Patent Application No. 2021-138186 filed on Aug. 26, 2021, incorporated herein by reference in its entirety.

### BACKGROUND

### 1. Technical Field

The present disclosure relates to a vehicle, and more particularly, to a vehicle that acquires traffic obstruction information related to traffic obstruction on a traveling route.

### 2. Description of Related Art

There is proposed a vehicle (automobile) configured to, when traffic congestion information is included in traffic information received by the vehicle via a navigation device, determine whether an uphill is present ahead of the vehicle in its traveling direction and there is traffic congestion within a range of a predetermined distance from the top of the uphill. When determination is made that there is traffic congestion within the range of the predetermined distance from the top of the uphill, the vehicle informs a user about the traffic congestion by voice or sound (see, for example, Japanese Unexamined Patent Application Publication No. 11-144193 (JP 11-144193 A)). Through the control described above, the vehicle can alert a driver by voice or sound when there is traffic congestion or other traffic obstruction at a location where the traffic congestion or other traffic obstruction is difficult to view from the traveling vehicle.

### SUMMARY

The vehicle described above determines whether the traffic congestion or other traffic obstruction is difficult to view from the traveling vehicle based on a road shape such as “uphill”. Therefore, even if determination is made that the obstruction is easy to view from the traveling vehicle based on the road shape, the driver may have difficulty in recognizing the obstruction depending on the condition of a vehicle between the vehicle and the location where the obstruction has occurred.

The present disclosure provides a vehicle that changes a notification method about the occurrence of obstruction depending on the condition of a vehicle between a vehicle and a location where the obstruction has occurred.

An embodiment of the present disclosure is as follows.

A vehicle according to a first aspect of the present disclosure includes a traffic obstruction information acquisition device configured to acquire traffic obstruction information related to traffic obstruction on a traveling route, a vehicle information acquisition device configured to acquire vehicle information related to a second vehicle located between a position of the vehicle and a location on the traveling route where the traffic obstruction has occurred, a notification device configured to give, to a driver of the vehicle, a notification by a first notification method and a notification by a second notification method, and a control device. The second notification method includes a notification function superior to a notification function of the first notification method. The control device is configured to notify the driver of the traffic obstruction information by the first notification method when the traffic obstruction has occurred on the traveling route based on the traffic obstruction information and a predetermined condition that brings difficulty for the driver in recognition of the traffic obstruction is not satisfied based on the vehicle information. The control device is configured to notify the driver of the traffic obstruction information by the second notification method when the traffic obstruction has occurred on the traveling route based on the traffic obstruction information and the predetermined condition that brings difficulty for the driver in the recognition of the traffic obstruction is satisfied based on the vehicle information.

In the vehicle of the present disclosure, the traffic obstruction information acquisition device acquires the traffic obstruction information related to the traffic obstruction on the traveling route, and the vehicle information acquisition device acquires the vehicle information related to the second vehicle located between the vehicle and the location on the traveling route where the traffic obstruction has occurred. In the case where the traffic obstruction has occurred on the traveling route based on the traffic obstruction information, the control device notifies the driver of the traffic obstruction information by using the notification device by the first notification method when the predetermined condition that brings difficulty for the driver in the recognition of the traffic obstruction is not satisfied based on the vehicle information, and notifies the driver of the traffic obstruction information by using the notification device by the second notification method when the predetermined condition that brings difficulty for the driver in the recognition of the traffic obstruction is satisfied based on the vehicle information. That is, the driver is notified of the traffic obstruction information by the first notification method or the second notification method by determining whether the driver has difficulty in the recognition of the traffic obstruction based on the vehicle information related to the second vehicle located between the vehicle and the location on the traveling route where the traffic obstruction has occurred. Thus, it is possible to change the notification method about the occurrence of the traffic obstruction depending on the condition of the vehicle between the vehicle and the location where the traffic obstruction has occurred. When a destination is set, the “traveling route” includes a route from a current location to the destination. When no destination is set, the “traveling route” includes a route within a predetermined range including a right or left turn in a traveling direction of the vehicle.

In the vehicle according to the first aspect of the present disclosure, the second notification method may be a method of notifying the driver both by the first notification method and by a notification method different from the first notification method.

In the vehicle according to the first aspect of the present disclosure, the notification device may include a display device and an audio output device. The first notification method may be a method of displaying a text, a symbol, and a diagram on the display device. The second notification method may be a method using both the first notification method and a notification method for outputting voice or sound from the audio output device.

In the vehicle according to the first aspect of the present disclosure, the control device may be configured to determine that the predetermined condition is satisfied when a height of the second vehicle is equal to or larger than a predetermined height. Thus, the driver can recognize the traffic obstruction more properly even when the second vehicle located between the vehicle and the location where the traffic obstruction has occurred hinders the recognition of the traffic obstruction.

In the vehicle according to the first aspect of the present disclosure, the control device may be configured to determine that the predetermined condition is satisfied when a degree of traffic congestion between the vehicle and the location where the traffic obstruction has occurred is lower than a predetermined degree based on the vehicle information. Thus, the driver can recognize the traffic obstruction more properly even when the traffic obstruction has occurred but the traffic has not been congested yet.

In the vehicle according to the first aspect of the present disclosure, the control device may be configured to store a driver attribute including at least one of an age, a driving experience, and a driving level of the driver. The control device may be configured to, when the driver attribute of the driver is an attribute that does not require the notification by the second notification method, notify the driver of the traffic obstruction information by the first notification method although the predetermined condition is satisfied. Thus, the driver's annoyance due to the notification by the second notification method can be reduced when the driver has high ability to recognize the traffic obstruction or the like.

In the vehicle according to the first aspect of the present disclosure, the control device may be configured to determine whether the driver is fatigued. The control device may be configured to, when the control device determines that the driver is fatigued, notify the driver of the traffic obstruction information by the second notification method although the predetermined condition is not satisfied.

In the vehicle of the present disclosure, the control device may be configured to determine whether the driver is fatigued, and when the control device determines that the driver is fatigued, notify the driver of the traffic obstruction information by the second notification method although the predetermined condition is not satisfied. Thus, the driver can recognize the traffic obstruction more properly even when the driver is fatigued. Accordingly, it is possible to suppress oversight of the occurrence of the traffic obstruction due to the driver's fatigue.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing an example of the configuration of a vehicle 20 according to an embodiment of the present disclosure as blocks arranged around a main electronic control unit 30;

FIG. 2 is a flowchart showing an example of an obstruction notification process to be executed by the main electronic control unit 30; and

FIG. 3 is a flowchart showing an example of the obstruction notification process in a modification.

### DETAILED DESCRIPTION OF EMBODIMENTS

An embodiment of the present disclosure will be described with reference to the drawings.

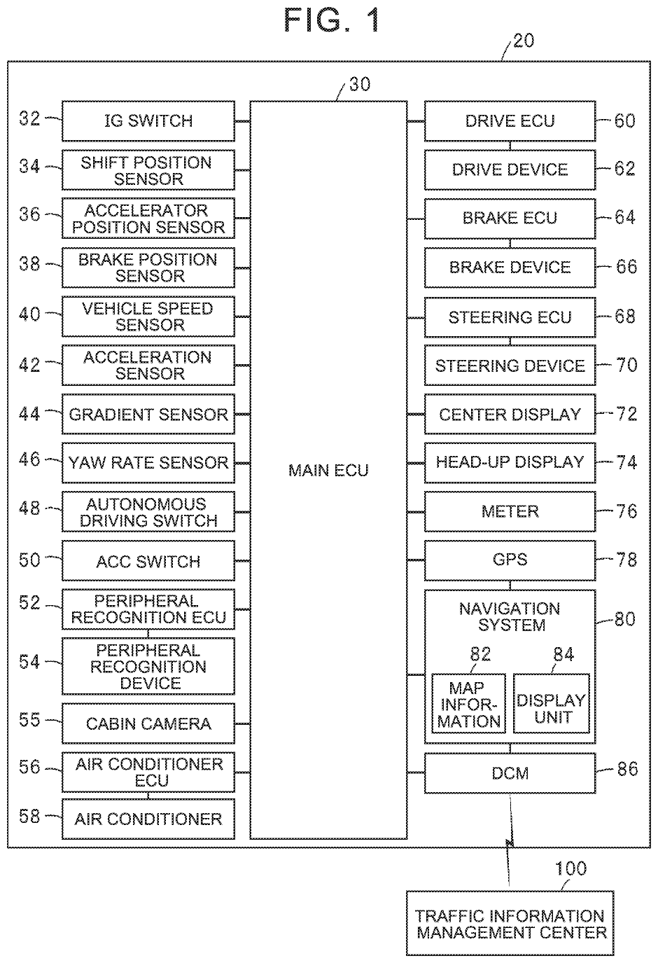

FIG. 1 is a block diagram showing an example of the configuration of a vehicle (automobile) 20 according to the embodiment of the present disclosure as blocks arranged around a main electronic control unit (hereinafter referred to as “main ECU”) 30. The vehicle 20 of the embodiment includes a drive device 62 that outputs a driving force to drive wheels (not shown), and a drive electronic control unit (hereinafter referred to as “drive ECU”) 60 that controls drive of the drive device 62.

Examples of the drive device 62 include a system including an engine and an automatic transmission, a hybrid system including an engine, a motor, and a battery, a fuel cell drive system including a fuel cell, a battery, and a motor, and an electrified system including a battery and a motor.

Although illustration is omitted, the drive ECU 60 is provided as a microcomputer mainly including a central processing unit (CPU). The drive ECU 60 includes a read-only memory (ROM), a random-access memory (RAM), a flash memory, an input port, an output port, a communication port, and the like in addition to the CPU. The drive ECU 60 controls the drive of the drive device 62 based on a drive control signal from the main ECU 30.

In addition to the drive device 62 and the drive ECU 60, the vehicle 20 of the embodiment includes an ignition switch (hereinafter referred to as “IG switch”) 32, a shift position sensor 34, an accelerator position sensor 36, a brake position sensor 38, a vehicle speed sensor 40, an acceleration sensor 42, a gradient sensor 44, a yaw rate sensor 46, an autonomous driving switch 48, an active cruise control switch (hereinafter referred to as “ACC switch”) 50, a peripheral recognition electronic control unit (hereinafter referred to as “peripheral recognition ECU”) 52, a peripheral recognition device 54, a cabin camera 55, an air conditioner electronic control unit (hereinafter referred to as “air conditioner ECU”) 56, an air conditioner 58, a brake electronic control unit (hereinafter referred to as “brake ECU”) 64, a brake device 66, a steering electronic control unit (hereinafter referred to as “steering ECU”) 68, a steering device 70, a center display 72, a head-up display 74, a meter 76, a global positioning system (or global positioning satellite; GPS) 78, a navigation system 80, and a data communication module (DCM) 86.

The IG switch turns ON ignition of the vehicle. In an electrified vehicle, the vehicle may include a switch for powering ON the vehicle instead of the IG switch. The shift position sensor 34 detects a position of a shift lever. The accelerator position sensor 36 detects an accelerator operation amount or the like based on an amount of depression of an accelerator pedal by a driver. The brake position sensor 38 detects a brake position or the like as an amount of depression of a brake pedal by the driver.

The vehicle speed sensor 40 detects a vehicle speed of the vehicle based on a wheel speed or the like. The acceleration sensor 42 detects, for example, an acceleration of the vehicle in its fore-and-aft direction. The gradient sensor 44 detects a road surface gradient. The yaw rate sensor 46 detects a lateral acceleration (yaw rate) in a lateral direction by a turning motion.

The autonomous driving switch 48 is a switch for choosing whether to perform autonomous driving as one type of driving assistance control. The ACC switch 50 is a switch for choosing whether to perform active cruise control as one type of the driving assistance device. The autonomous driving switch 48 and the ACC switch 50 are provided on or near a steering wheel or an instrument panel in front of a driver's seat. The autonomous driving switch 48 and the ACC switch 50 also serve as switches for transition to a driving preference setting process for setting a driver's preference mode as a driving mode in the driving assistance control. In the driver's preference mode, driver's preferences for driving of the vehicle are set by using the center display 72. The driving preference setting process includes a process of displaying preset options on the center display 72 for selection of driving preference items such as a vehicle-to-vehicle distance from a vehicle ahead, a degree of acceleration or deceleration, a degree of lane change, and a driving lane, and a process of setting values desired by the driver by manually inputting specific numerical values or the like by using the center display 72.

Although illustration is omitted, the peripheral recognition ECU 52 is provided as a microprocessor mainly including a CPU. In addition to the CPU, the peripheral recognition ECU 52 includes a ROM for storing a processing program, a RAM for temporarily storing data, input and output ports, and a communication port. Information on the vehicle and its surroundings (for example, vehicle-to-vehicle distances D1 and D2 from other vehicles ahead of and behind the vehicle, vehicle speeds of other vehicles, and a traveling position of the vehicle in a lane on a road) is input to the peripheral recognition ECU 52 from the peripheral recognition device 54 via the input port. Examples of the peripheral recognition device 54 include a front camera, a rear camera, a millimeter wave radar, a submillimeter wave radar, an infrared laser radar, and a sonar. The cabin camera 55 is arranged in front of the driver's seat and images the driver and a cabin.

Although illustration is omitted, the air conditioner ECU 56 is provided as a microcomputer mainly including a CPU. The air conditioner ECU 56 includes a ROM, a RAM, a flash memory, an input port, an output port, a communication port, and the like in addition to the CPU. The air conditioner ECU 56 is built in the air conditioner 58 that conditions air in the cabin, and controls drive of, for example, an air conditioner compressor in the air conditioner so that the temperature in the cabin reaches a set temperature.

Although illustration is omitted, the brake ECU 64 is provided as a microcomputer mainly including a CPU. The brake ECU 64 includes a ROM, a RAM, a flash memory, an input port, an output port, a communication port, and the like in addition to the CPU. The brake ECU 64 controls drive of the known hydraulically driven brake device 66. The brake device 66 is configured to apply a braking force generated by a brake pedaling force that is generated by depressing the brake pedal, and apply a braking force generated by hydraulic pressure adjustment.

Although illustration is omitted, the steering ECU 68 is provided as a microcomputer mainly including a CPU. The steering ECU 68 includes a ROM, a RAM, a flash memory, an input port, an output port, a communication port, and the like in addition to the CPU. The steering ECU 68 controls drive of an actuator of the steering device 70 in which the steering wheel (not shown) and the drive wheels (not shown) are mechanically connected via a steering shaft. The steering device 70 steers the drive wheels based on a driver's steering operation, and also steers the drive wheels by driving the actuator by the steering ECU 68 based on a steering control signal from the main electronic control unit 30.

The center display 72 is arranged at the center in front of the driver's seat and a passenger's seat. The center display 72 also functions as a touch panel. The center display 72 is used to make various settings on the vehicle and execute audio applications and applications of various media. The center display 72 also functions as a display unit 84 of the navigation system to perform map navigation. A loudspeaker or the like is attached to the center display 72.

The head-up display 74 provides an image (formed at infinity) of information for the driver on a windshield. For example, the head-up display 74 displays a speed or a navigation guide. The meter 76 is built in, for example, the instrument panel in front of the driver's seat.

The GPS 78 detects a position of the vehicle based on signals transmitted from a plurality of GPS satellites.

The navigation system 80 guides the vehicle to a set destination. The navigation system 80 includes map information 82 and the display unit 84. The navigation system 80 communicates with a traffic information management center 100 via the data communication module (DCM) 86 to acquire road traffic information and update the map information 82 by acquiring the map information as necessary. When the destination is set, the navigation system 80 sets a route based on information on the destination, information on a current location (current position of the vehicle) that is acquired by the GPS 78, and the map information 82.

The data communication module (DCM) 86 transmits information on the vehicle to the traffic information management center 100, and receives information on other vehicles and road traffic information from the traffic information management center 100. Examples of the information on the vehicle include specifications, a current location, a vehicle speed, traveling power, and a traveling mode of the vehicle. Examples of the information on other vehicles include specifications, current locations, vehicle speeds, traveling power, and traveling modes of the other vehicles similarly to the information on the vehicle. Examples of the specifications of the vehicle and the other vehicles include a vehicle type (electrified vehicle, hybrid electric vehicle, or fuel cell electric vehicle) and a size (vehicle length, vehicle width, and vehicle height). Examples of the road traffic information include information on current and future traffic congestions (including information on start and end points of traffic congestions), information on accidents, information on fallen objects, information on road surface conditions (including information on whether the road surface is slippery), information on traffic regulations, information on weather, information on maps, and information on other vehicles between the vehicle and a location of an obstruction that hinders traffic, such as a traffic congestion, an accident, or a fallen object. The DCM 86 communicates with the traffic information management center 100 in response to requests or at predetermined time intervals (for example, every 30 seconds, every minute, or every 2 minutes).

Although illustration is omitted, the main electronic control unit 30 is provided as a microcomputer mainly including a CPU. The main electronic control unit 30 includes a ROM, a RAM, a flash memory, an input port, an output port, a communication port, and the like in addition to the CPU. Various signals are input to the main electronic control unit 30 via the input port. Examples of information input via the input port include an ignition switch signal from the ignition switch 32, a shift position from the shift position sensor 34, an accelerator operation amount from the accelerator position sensor 36, and a brake position from the brake position sensor 38. Examples of the information input via the input port also include a vehicle speed V from the vehicle speed sensor 40, an acceleration from the acceleration sensor 42, a gradient from the gradient sensor 44, and a yaw rate from the yaw rate sensor 46. Examples of the information input via the input port further include an autonomous driving instruction signal from the autonomous driving switch 48, and an ACC instruction signal from the ACC switch 50. Various signals are output from the main electronic control unit 30 via the output port. Examples of information output via the output port include a display control signal to the center display 72, a display control signal to the head-up display 74, and a display signal to the meter 76.

The main electronic control unit 30 communicates with, for example, the peripheral recognition ECU 52, the air conditioner ECU 56, the drive ECU 60, the brake ECU 64, the steering ECU 68, and the navigation system 80 to exchange various types of information.

The main electronic control unit 30 sets a requested driving force and requested power based on the accelerator operation amount from the accelerator position sensor 36 and the vehicle speed from the vehicle speed sensor 40, and transmits a drive control signal to the drive ECU 60 so that the requested driving force and the requested power are output from the drive device 62.

When the autonomous driving switch 48 is operated to give an instruction to execute the autonomous driving, the main electronic control unit 30 selects the driver's preference mode, and executes the autonomous driving based on the set vehicle-to-vehicle distance from a vehicle ahead, the set degree of acceleration or deceleration, the set degree of lane change, and the set driving lane. For example, when no vehicle is recognized ahead within a range of a first predetermined distance (for example, 200 m or 300 m) by the peripheral recognition device 54, the main electronic control unit 30 transmits control signals to the drive ECU 60, the brake ECU 64, and the steering ECU 68 to cause the vehicle to travel at a vehicle speed equal to or lower than a legal speed. When a vehicle is recognized ahead within the range of the first predetermined distance by the peripheral recognition device 54, the main electronic control unit 30 transmits control signals to the drive ECU 60, the brake ECU 64, and the steering ECU 68 to cause the vehicle to travel within the range of the legal speed while keeping a predetermined vehicle-to-vehicle distance from the vehicle ahead, or to overtake the vehicle ahead by changing the lane.

When the ACC switch 50 is operated to give an instruction to execute the active cruise control, the main electronic control unit 30 executes the active cruise control based on, for example, the set vehicle speed and the set vehicle-to-vehicle distance from a vehicle ahead. For example, when no vehicle is recognized ahead within the range of the first predetermined distance (for example, 200 m or 300 m) by the peripheral recognition device 54, the main electronic control unit 30 transmits control signals to the drive ECU 60 and the brake ECU 64 to cause the vehicle to travel at the vehicle speed set by using the ACC switch 50. When a vehicle is recognized ahead within the range of the first predetermined distance by the peripheral recognition device 54, the main electronic control unit 30 transmits control signals to the drive ECU 60 and the brake ECU 64 to cause the vehicle to follow the vehicle ahead at the set vehicle-to-vehicle distance from the vehicle ahead within the range of the vehicle speed set by using the ACC switch 50.

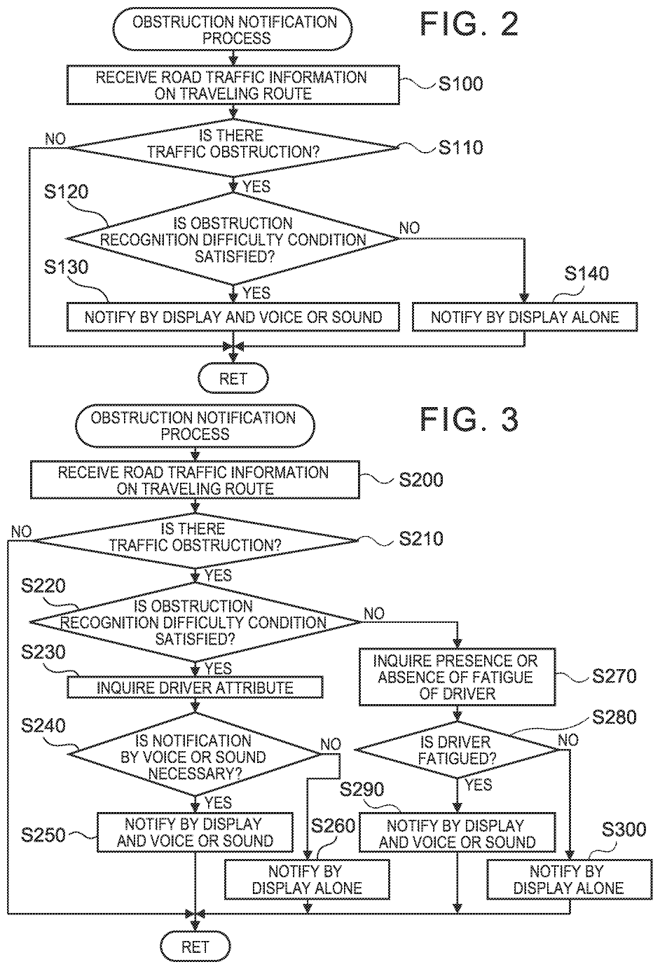

Next, description will be given about operations of the vehicle 20 configured as described above, in particular, operations when traffic obstruction occurs on a traveling route. When a destination is set, a route from a current location to the destination corresponds to the traveling route. When no destination is set, a route within a predetermined range (for example, 5 km or 10 km) including a right or left turn in a traveling direction of the vehicle corresponds to the traveling route. FIG. 2 is a flowchart showing an example of an obstruction notification process to be executed by the main electronic control unit 30.

When the obstruction notification process is started, the main electronic control unit 30 first receives road traffic information (traffic situation) on the traveling route from the traffic information management center 100 via the DCM 86 (Step S100). Subsequently, the main electronic control unit 30 determines whether traffic obstruction has occurred on the traveling route based on the received road traffic information (traffic situation) (Step S110). Examples of the traffic obstruction include a traffic congestion, an accident, a fallen object, a traffic regulation, and a slippery road surface condition. When the main electronic control unit 30 determines that no traffic obstruction has occurred on the traveling route (No in Step S110), the main electronic control unit 30 terminates this process because the obstruction notification is unnecessary.

When the main electronic control unit 30 determines in Step S110 that the traffic obstruction has occurred on the traveling route (Yes in Step S110), the main electronic control unit 30 determines whether a condition that brings difficulty for the driver in recognition of the obstruction on the traveling route (obstruction recognition difficulty condition) is satisfied (Step S120). Examples of the obstruction recognition difficulty condition include a condition that the obstruction has occurred at a point with low visibility, a condition that the height of a vehicle ahead is equal to or larger than a predetermined height, a condition that an accident that causes no traffic congestion has occurred, a condition that a fallen object that causes no traffic congestion is present, a condition that a traffic congestion at an exit lane of a motor highway such as an expressway extends to the vicinity of a main line, a condition that the road surface is slippery, a condition that a construction site that causes no traffic congestion is present, and a condition that the road is suddenly blocked due to stormy weather or the like. Regarding the condition that the height of a vehicle ahead is equal to or larger than the predetermined height, the main electronic control unit 30 can make the determination by using information on another vehicle (in particular, a vehicle height) between the vehicle and the location where the traffic obstruction has occurred. Regarding the condition that an accident that causes no traffic congestion has occurred and the condition that a fallen object that causes no traffic congestion is present, the main electronic control unit 30 can also make the determination by using the information on the other vehicle (in particular, a current location and a vehicle speed) between the vehicle and the location where the obstruction has occurred, together with information on the occurrence of the accident and information on the presence of the fallen object. Regarding the condition that a traffic congestion at an exit lane of a motor highway such as an expressway extends to the vicinity of a main line and the condition that a construction site that causes no traffic congestion is present, the main electronic control unit 30 can also make the determination by using the information on the other vehicle (in particular, the current location and the vehicle speed) between the vehicle and the location where the obstruction has occurred.

When the main electronic control unit 30 determines in Step S120 that any obstruction recognition difficulty condition is satisfied (Yes in Step S120), the main electronic control unit 30 notifies the driver of the traffic obstruction on the traveling route by displaying the obstruction on the center display 72 and by outputting voice or sound from the loudspeaker attached to the center display 72 (Step S130). Then, the main electronic control unit 30 terminates this process. When the main electronic control unit 30 determines in Step S120 that no obstruction recognition difficulty condition is satisfied (No in Step S120), the main electronic control unit 30 notifies the driver of the traffic obstruction on the traveling route by displaying the obstruction on the center display 72 without performing the notification by voice or sound (Step S140). Then, the main electronic control unit 30 terminates this process.

In the vehicle 20 of the embodiment described above, when the traffic obstruction has occurred on the traveling route, determination is made whether the obstruction recognition difficulty condition that brings difficulty for the driver in the recognition of the obstruction on the traveling route is satisfied by using the information on the other vehicle between the vehicle and the location where the obstruction has occurred. When no obstruction recognition difficulty condition is satisfied, the driver is notified of the traffic obstruction on the traveling route by displaying the obstruction on the center display 72 without performing the notification by voice or sound. When any obstruction recognition difficulty condition is satisfied, the driver is notified of the traffic obstruction on the traveling route by displaying the obstruction on the center display 72 and by outputting voice or sound indicating the obstruction from the loudspeaker attached to the center display 72. Thus, it is possible to change the notification method about the occurrence of the obstruction depending on the condition of the vehicle between the vehicle and the location where the obstruction has occurred.

In the vehicle 20 of the embodiment, when any obstruction recognition difficulty condition is satisfied, the driver is notified of the traffic obstruction on the traveling route by displaying the obstruction on the center display 72 and by outputting voice or sound indicating the obstruction from the loudspeaker attached to the center display 72. When the notification by voice or sound is unnecessary due to a driver attribute such as the age, driving experience, and driving level of the driver although any obstruction recognition difficulty condition is satisfied, the driver may be notified of the traffic obstruction on the traveling route by displaying the obstruction on the center display 72 without performing the notification by voice or sound. In the vehicle 20 of the embodiment, when no obstruction recognition difficulty condition is satisfied, the driver is notified of the traffic obstruction on the traveling route by displaying the obstruction on the center display 72 without performing the notification by voice or sound. When determination is made that the driver is fatigued although no obstruction recognition difficulty condition is satisfied, the driver may be notified of the traffic obstruction on the traveling route by displaying the obstruction on the center display 72 and by outputting voice or sound indicating the obstruction from the loudspeaker attached to the center display 72. FIG. 3 shows an example of an obstruction notification process in consideration of these cases. Hereinafter, the obstruction notification process of FIG. 3 will be described.

When the obstruction notification process of FIG. 3 is started, the main electronic control unit 30 receives road traffic information (traffic situation) on the traveling route (Step S200) and determines whether traffic obstruction has occurred on the traveling route based on the received road traffic information (traffic situation) (Step S210) as in Steps S100 and S110 of the obstruction notification process of FIG. 2.

When the main electronic control unit 30 determines in Step S220 that any obstruction recognition difficulty condition is satisfied, the main electronic control unit 30 inquires the driver attribute (Step S230). Based on the driver attribute, the main electronic control unit 30 determines whether the notification by voice or sound is necessary (Step S240). The driver attribute includes the age, driving experience, and driving level of the driver. Examples of the driver attribute that requires the notification by voice or sound include a case where the driver is an elderly person, a case where the driver is a young person, a case where the number of years of driving experience is smaller than a predetermined number of years (for example, one or two years), and a case where the driver is registered as being poor at driving. When the main electronic control unit 30 determines that the notification by voice or sound is necessary due to the driver attribute (Yes in Step S240), the main electronic control unit 30 notifies the driver of the traffic obstruction on the traveling route by displaying the obstruction on the center display 72 and by outputting voice or sound from the loudspeaker attached to the center display 72 (Step S250). Then, the main electronic control unit 30 terminates this process. When the main electronic control unit 30 determines that the notification by voice or sound is unnecessary due to the driver attribute (No in Step S240), the main electronic control unit 30 notifies the driver of the traffic obstruction on the traveling route by displaying the obstruction on the center display 72 without performing the notification by voice or sound (Step S260). Then, the main electronic control unit 30 terminates this process. Thus, it is possible to reduce the occurrence of a case where the driver is annoyed by giving the notification by voice or sound to the driver having the driver attribute that does not require the notification by voice or sound, that is, the driver who has high ability to recognize the obstruction on the traveling route. In addition, it is possible to reduce an electric power to perform the notification by voice or sound.

When the main electronic control unit 30 determines in Step S220 that no obstruction recognition difficulty condition is satisfied, the main electronic control unit 30 inquires the presence or absence of fatigue of the driver (Step S270). Based on the presence or absence of fatigue of the driver, the main electronic control unit 30 determines whether the driver is fatigued (Step S280). The presence or absence of fatigue of the driver can be determined by analyzing a driving period and a driver's motion. For example, the main electronic control unit 30 can determine that the driver is fatigued when the driving period is equal to or longer than a predetermined period (for example, 2 hours). Alternatively, the main electronic control unit 30 can determine that the driver is fatigued based on eye movement of the driver that is imaged by the cabin camera 55. When the main electronic control unit 30 determines that the driver is fatigued (Yes in Step S280), the main electronic control unit 30 notifies the driver of the traffic obstruction on the traveling route by displaying the obstruction on the center display 72 and by outputting voice or sound from the loudspeaker attached to the center display 72 (Step S290). Then, the main electronic control unit 30 terminates this process. When the main electronic control unit 30 determines that the driver is not fatigued (No in Step S280), the main electronic control unit 30 notifies the driver of the traffic obstruction on the traveling route by displaying the obstruction on the center display 72 without performing the notification by voice or sound (Step S300). Then, the main electronic control unit 30 terminates this process. Thus, the driver can recognize the obstruction more properly even when the driver is fatigued. Accordingly, it is possible to suppress oversight of the occurrence of the obstruction due to the driver's fatigue.

In the vehicle 20 of the embodiment, the devices are controlled by the plurality of electronic control units such as the main electronic control unit 30, the peripheral recognition ECU 52, the drive ECU 60, the brake ECU 64, and the steering ECU 68. The devices may be controlled by a single electronic control unit or by a plurality of electronic control units serving also as a part of these electronic control units. In the present embodiment, the loudspeaker attached to the center display 72 is used for the notification, but the center display 72 and the loudspeaker may be provided separately. In the present embodiment, the notification is performed by voice or sound from the loudspeaker together with the notification by display on the center display 72, but the notification may be performed only by voice or sound from the loudspeaker.

The main electronic control unit 30, the navigation system 80, and the DCM 86 are examples of a “traffic obstruction information acquisition device”. The main electronic control unit 30, the navigation system 80, and the DCM 86 are examples of a “vehicle information acquisition device”. The center display 72 is an example of a “notification device”. The main electronic control unit 30 is an example of a “control device”. The center display 72 is an example of a “display device”. The loudspeaker attached to the center display 72 is an example of an “audio output device”. The vehicle including the main electronic control unit 30 that notifies the driver of the traffic obstruction on the traveling route is an example of a “first vehicle”. The other vehicle is an example of a “second vehicle”.

The embodiment is merely a specific example of the present disclosure.

Although the modes for carrying out the present disclosure have been described above based on the embodiment, the present disclosure is not limited to the embodiment, and may be embodied in various modes without departing from the spirit of the present disclosure.

The present disclosure is applicable to, for example, manufacturing industry of vehicles.

What is claimed is:

1. A vehicle comprising:
a traffic obstruction information acquisition device configured to acquire traffic obstruction information related to traffic obstruction on a traveling route;
a vehicle information acquisition device configured to acquire vehicle information related to a second vehicle located between a position of the vehicle and a location on the traveling route where the traffic obstruction has occurred;
a notification device configured to give, to a driver of the vehicle, a notification by a first notification method and a notification by a second notification method, the second notification method including a notification function superior to a notification function of the first notification method; and
a control device configured to
notify the driver of the traffic obstruction information by the first notification method when the traffic obstruction has occurred on the traveling route based on the traffic obstruction information and a predetermined condition that brings difficulty for the driver in recognition of the traffic obstruction is not satisfied based on the vehicle information, and
notify the driver of the traffic obstruction information by the second notification method when the traffic obstruction has occurred on the traveling route based on the traffic obstruction information and the predetermined condition that brings difficulty for the driver in the recognition of the traffic obstruction is satisfied based on the vehicle information.

2. The vehicle according to claim 1, wherein the second notification method is a method of notifying the driver both by the first notification method and by a notification method different from the first notification method.

3. The vehicle according to claim 2, wherein:
the notification device includes a display device and an audio output device;
the first notification method is a method of displaying a text, a symbol, and a diagram on the display device; and
the second notification method is a method using both the first notification method and a notification method for outputting voice or sound from the audio output device.

4. The vehicle according to claim 1, wherein the control device is configured to determine that the predetermined condition is satisfied when a height of the second vehicle is equal to or larger than a predetermined height.

5. The vehicle according to claim 1, wherein the control device is configured to determine that the predetermined condition is satisfied when a degree of traffic congestion between the vehicle and the location where the traffic obstruction has occurred is lower than a predetermined degree based on the vehicle information.

6. The vehicle according to claim 1, wherein the control device is configured to:
store a driver attribute including at least one of an age, a driving experience, and a driving level of the driver; and
when the driver attribute of the driver is an attribute that does not require the notification by the second notification method, notify the driver of the traffic obstruction information by the first notification method although the predetermined condition is satisfied.

7. The vehicle according to claim 1, wherein the control device is configured to:
determine whether the driver is fatigued; and
when the control device determines that the driver is fatigued, notify the driver of the traffic obstruction information by the second notification method although the predetermined condition is not satisfied.
